(19) United States
(12) Patent Application Publication
(10) Pub. No.: US 2023/0160469 A1
(43) Pub. Date: May 25, 2023

(54) RELEASE DEVICE

(71) Applicant: KABUSHIKI KAISHA TOKAI-RIKA-DENKI-SEISAKUSHO, Aichi (JP)

(72) Inventors: Shigeki YOSHIDA, Aichi (JP); Yuji OSA, Aichi (JP)

(21) Appl. No.: 17/919,744

(22) PCT Filed: Mar. 4, 2021
(86) PCT No.: PCT/JP2021/008505

§ 371 Date: Oct. 18, 2022

(30) Foreign Application Priority Data
Apr. 23, 2020 (JP) 2020-076925

(51) Int. Cl. F16H 63/34

(52) U.S. Cl. CPC F16H 63/3466

(57) ABSTRACT

In an actuator a shaft and a motor are coupled together by a coupling mechanism. The coupling of the shaft to the motor by the coupling mechanism is released by rotational operation force on the shaft, and a parking position of a transmission is released by the shaft being rotated. There is accordingly no need for a device to release the coupling between the shaft and the motor by the coupling mechanism, enabling a simple configuration for the actuator.

### TECHNICAL FIELD

The present invention relates to a release device in which a rotating section is rotated to release a parking position of a transmission.

### BACKGROUND ART

In an electrical actuator described in Japanese Patent Application Laid-Open (JP-A) No. 2005-164037, rotation of a ring gear of a cogwheel set is anchored by a solenoid, and the cogwheel set couples an electric motor to a rotation stopper. By the electric motor being driven the rotation stopper is accordingly rotated via the cogwheel set, and a parking position of an automatic transmission is released.

In such an electrical actuator, the rotation anchoring of the ring gear in the cogwheel set is released by the solenoid, and coupling of the electric motor to the rotation stopper by the cogwheel set is released. The rotation stopper is thereby rotationally operated via a back-up shifter and attachment pin etc., and the parking position of the automatic transmission is released.

### SUMMARY OF INVENTION

### Technical Problem

In consideration of the above circumstances, an object of the present invention is to obtain a release device whose configuration can be simplified.

### Solution to Problem

A release device of a first aspect of the present invention includes: a rotating section configured to be provided at a transmission of a vehicle and configured to release a parking position of the transmission by being rotated; a drive mechanism; and a coupling mechanism configured to couple the rotating section to the drive mechanism such that the rotating section is rotated by the drive mechanism being driven, and such that coupling between the rotating section and the drive mechanism is released by operational force applied to the rotating section so that the rotating section is rotated.

A release device of a second aspect of the present invention is the release device of the first aspect of the present invention wherein the coupling mechanism is configured to couple the rotating section to the drive mechanism using urging force, and configured such that coupling between the rotating section and the drive mechanism by the coupling mechanism is released against the urging force by the operational force applied to the rotating section.

A release device of a third aspect of the present invention is the release device of the first aspect or the second aspect of the present invention further including a limiting mechanism provided at the coupling mechanism and configured to limit rotation of the rotating section.

A release device of a fourth aspect of the present invention is the release device of the third aspect of the present invention further including a worm provided at the limiting mechanism, and a worm wheel provided at the limiting mechanism, the worm wheel being configured to mesh with the worm, and the worm limiting rotation of the worm wheel such that rotation of the rotating section is limited.

### Advantageous Effects of Invention

In the release device of the first aspect of the present invention, the rotating section is provided at the vehicle transmission and the coupling mechanism couples the rotating section to the drive mechanism such that the rotating section is rotated by the drive mechanism being driven and the parking position of the transmission is released.

When the rotating section is operated, the coupling between the rotating section and the drive mechanism by the coupling mechanism is released by the operational force applied to the rotating section, and the rotating section is rotated. There is accordingly no need for a device to release the coupling between the rotating section and the drive mechanism by the coupling mechanism, enabling the configuration to be simplified.

In the release device of the second aspect of the present invention, the coupling mechanism couples the rotating section to the drive mechanism using the urging force. The coupling between the rotating section and the drive mechanism by the coupling mechanism is released against the urging force by operational force applied to the rotating section when the rotating section is operated. This enables the coupling mechanism to couple the rotating section to the drive mechanism and also enables the coupling between the rotating section and the drive mechanism by the coupling mechanism to be released, all with a simple configuration.

In the release device of the third aspect of the present invention, the limiting mechanism of the coupling mechanism limit rotation of the rotating section. This accordingly enables undesired rotation of the rotating section to be suppressed.

In the release device of the fourth aspect of the present invention, the worm and the worm wheel of the limiting mechanism are meshed together, and the worm limiting rotation of the worm wheel such that rotation of the rotating section is limited. This enables rotation of the rotating section to be limited with a simple configuration.

### BRIEF DESCRIPTION OF DRAWINGS

FIG. 1 is a perspective view of relevant portions of a transmission applied with an actuator according to an exemplary embodiment of the present invention, as viewed diagonally from a front-left.

FIG. 2 is a perspective view of an actuator according to an exemplary embodiment of the present invention, as viewed diagonally from a rear-left.

FIG. 3A is a perspective view illustrating relevant portions of an actuator according to an exemplary embodiment of the present invention while coupled.

FIG. 3B is a perspective view illustrating relevant portions of an actuator according to an exemplary embodiment of the present invention while coupling has been released.

FIG. 4 is an exploded perspective view illustrating relevant portions of an actuator according to an exemplary embodiment of the present invention.

### DESCRIPTION OF EMBODIMENTS

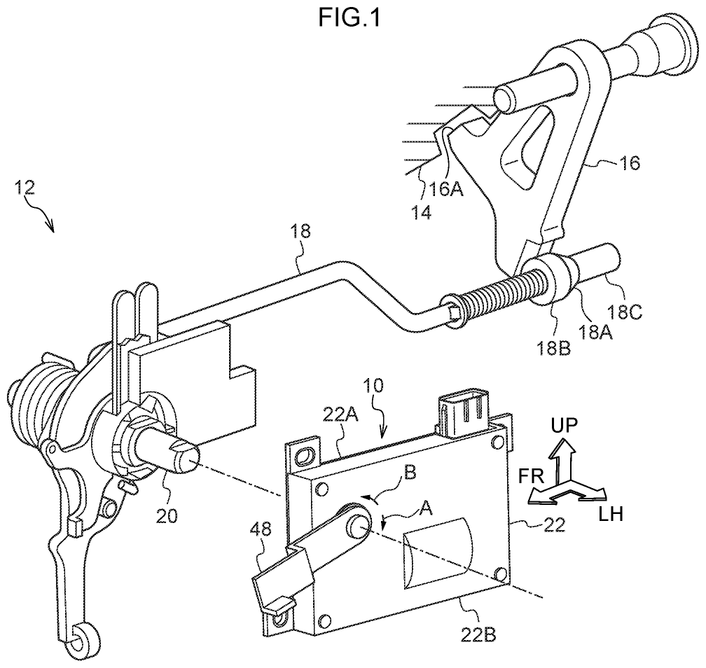

FIG. 1 is a perspective view illustrating relevant portions of a transmission 12 (automatic transmission) applied with an actuator 10 serving as a release device according to an exemplary embodiment of the present invention, as viewed diagonally from the front-left. Note that in the drawings a front of the transmission 12 is indicated by arrow FR, a left of the transmission 12 is indicated by arrow LH, and upward in the transmission 12 is indicated by arrow UP.

As illustrated in FIG. 1, in the present exemplary embodiment a lock gear 14 is provided as a lock target in the transmission 12 of a vehicle (automobile). The lock gear 14 is able to rotate with a rotation center axis of the lock gear 14 parallel to a front-rear direction. A shift position of the transmission 12 is configured to be a parking position (parking lock of the vehicle is actuated) when rotation of the lock gear 14 has been locked, and the parking position of the transmission 12 is released (the vehicle parking lock is released) when locking of the rotation of the lock gear 14 has been released.

A substantially triangular plate shaped lock plate 16 serving as a locking member is provided at a left side of the lock gear 14, and the lock plate 16 is configured so as to be rotatable about an upper end portion thereof. The rotation center axis of the lock plate 16 is parallel to the front-rear direction, and the lock plate 16 is urged toward the left side. A locking portion 16A is integrally formed at a right end portion (right side and lower side end portion) of the lock plate 16, and the locking portion 16A projects out toward the right side.

A rear end portion of a substantially columnar switching shaft 18 serving as a switching member is disposed at the left side of a lower end portion (left side and lower side end portion) of the lock plate 16, with the switching shaft 18 extending along a substantially front-rear direction, and capable of moving within a specific range in the front-rear direction. A substantially columner switching portion 18A is coaxially provided at a rear end portion of the switching shaft 18, with a large diameter portion 18B coaxially provided at a front portion of the switching portion 18A, and a small diameter portion 18C coaxially provided at a rear portion of the switching portion 18A. The diameter of the large diameter portion 18B is larger than the diameter of the small diameter portion 18C, with the diameter of a portion between the large diameter portion 18B and the small diameter portion 18C gradually larger on progression from the small diameter portion 18C toward the large diameter portion 18B. The large diameter portion 18B engages with a lower end portion of the lock plate 16 when the switching shaft 18 has been moved toward the rear side, and the locking portion 16A of the lock plate 16 engages (meshes) with the lock gear 14 by the lock plate 16 being swung toward the right side, thereby locking rotation of the lock gear 14. The small diameter portion 18C is engaged with the lower end portion of the lock plate 16 when the switching shaft 18 has been moved toward the front side, and the engagement of the locking portion 16A with the lock gear 14 is released by the lock plate 16 being swung toward the left side, thereby releasing the lock on rotation of the lock gear 14.

A substantially columner link shaft 20 serving as a link section is mechanically linked with a front end portion of the switching shaft 18, with the link shaft 20 configured so as to be rotatable. A rotation center axis of the link shaft 20 is parallel to a left-right direction, with the switching shaft 18 being moved toward the rear side when the link shaft 20 has been rotated in a lock direction A (see FIG. 1 and the like), and the switching shaft 18 being moved toward the front side when the link shaft 20 has been rotated in a release direction B (see FIG. 1 and the like).

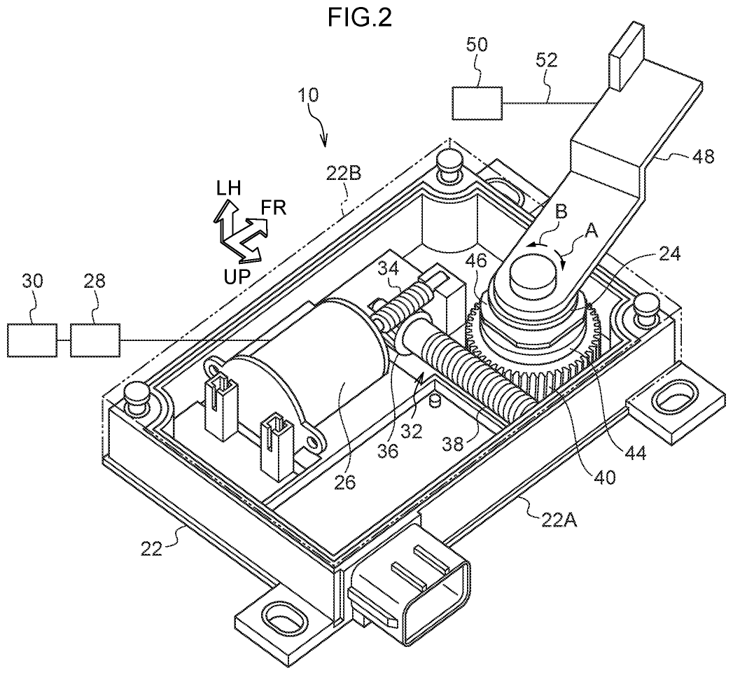

The actuator 10 (see FIG. 2) is provided at the left side of the link shaft 20.

A cuboidal box shaped case 22 serving as a housing body is provided at the actuator 10, with the case 22 being configured by an assembly of a right case 22A on the right side and a left case 22B on the left side.

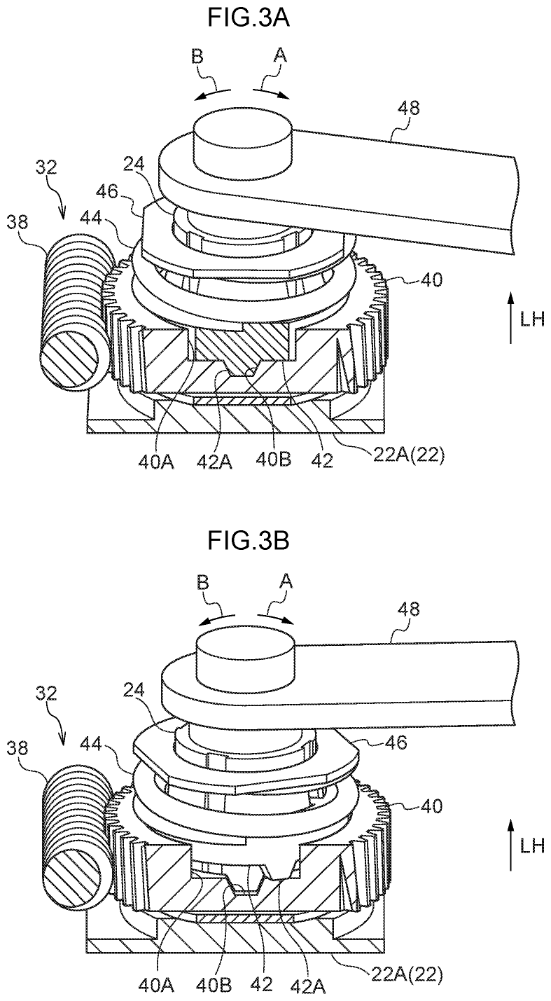

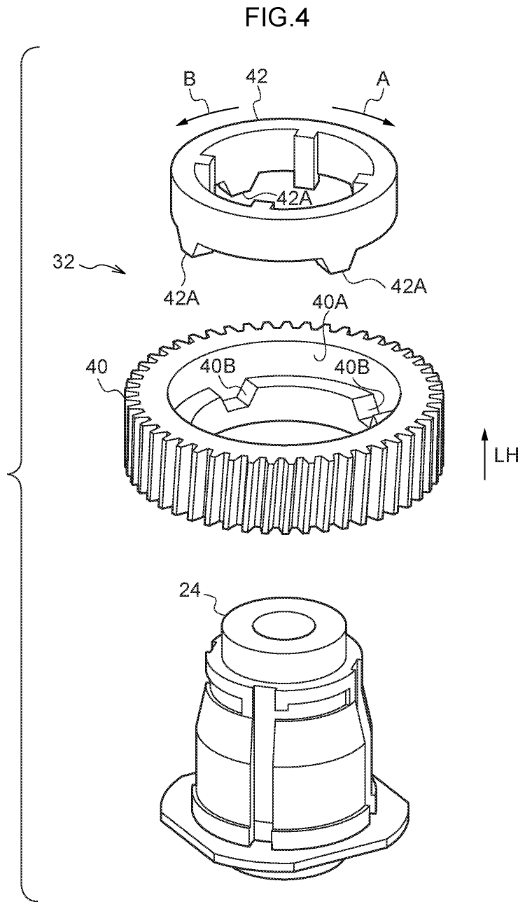

A substantially cylindrical shaft 24 (see FIG. 3A and FIG. 4) serving as a rotating section is provided inside the case 22, with the shaft 24 configured so as to be rotatable. A rotation center axis of the shaft 24 is parallel to the left-right direction, with a left end and a right end of the shaft 24 respectively exposed at the left side and the right side of the case 22. The link shaft 20 is coaxially fitted into the shaft 24 from the right side in such a manner that the shaft 24 is able to integrally rotate together with the link shaft 20.

A motor 26 serving as a drive mechanism is fixed inside the case 22, with an output shaft of the motor 26 extending forward. The motor 26 is electrically connected to a control device 28 of the vehicle, and the control device 28 is electrically connected to an emergency release switch 30 of the vehicle. The control device 28 controls the motor 26 based on operation of the emergency release switch 30 by an occupant (in particular a driver) of the vehicle, and the motor 26 is driven.

A coupling mechanism 32 is provided between the shaft 24 and the motor 26.

A worm 34 serving as a first gear is provided at the coupling mechanism 32. The worm 34 is fixed coaxially to the output shaft of the motor 26, and the motor 26 is driven to rotate the worm 34.

A helical gear 36 (worm wheel) serving as a second gear is meshed with the right side of the worm 34, and the helical gear 36 is rotatably supported inside the case 22 with an axial direction parallel to an up-down direction. The worm 34 restricts rotation of the helical gear 36 (so-called self-locking), and the helical gear 36 is rotated by the worm 34 being rotated.

A worm shaft 38 (worm, see FIG. 3A) serving as a third gear configuring a limiting mechanism is coaxially provided at an upper side of the helical gear 36, with the worm shaft 38 rotatably supported inside the case 22, and integrally rotated together with the helical gear 36.

A substantially cylindrical coupling gear 40 (worm wheel, see FIG. 3A and FIG. 4) serving as a fourth gear (coupled member) configuring the limiting mechanism is meshed with a front side of the worm shaft 38. The shaft 24 is coaxially inserted into and fitted together with the inside of the coupling gear 40, such that the coupling gear 40 is rotatably supported by the shaft 24 and also restricted from moving toward the right side. The worm shaft 38 restricts rotation of the coupling gear 40 (so-called self-locking), and the coupling gear 40 is rotated by the worm shaft 38 being rotated.

A cylindrical insertion hole 40A is coaxially formed at a portion at the radial direction inside and left side of a circumferential wall of the coupling gear 40, with the insertion hole 40A opening toward the left side. Plural (four in the present exemplary embodiment) coupling recesses 40B serving as coupled portions are integrally formed at a right-side face (bottom face) of the insertion hole 40A, with the plural coupling recesses 40B being arranged at uniform intervals around the circumferential direction of the insertion hole 40A, and with each respectively opening toward the left side. Each of the coupling recesses 40B has a trapezoidal profile in cross-section taken along the circumferential direction of the insertion hole 40A, with a dimension of each of the coupling recesses 40B in the insertion hole 40A circumferential direction getting larger on progression toward the left side.

A substantially cylindrical clutch 42 (see FIG. 3A and FIG. 4) serving as a coupling member is provided at the left side of the coupling gear 40. The shaft 24 is coaxially inserted into and fitted together at the inside of the clutch 42, and the clutch 42 is not able to rotate relative to the shaft 24 (i.e. is able to integrally rotate therewith) and is supported so as to be able to move along its axial direction (the left-right direction).

Plural (four in the present exemplary embodiment) coupling protrusions 42A serving as coupling portions are integrally formed at a right-side end of the clutch 42, with the plural coupling protrusions 42A disposed at uniform intervals around the circumferential direction of the clutch 42, and with each respectively protruding toward the right side. Each of the coupling protrusions 42A has a trapezoidal profile in cross-section taken along the clutch 42 circumferential direction, with a dimension of the coupling protrusion 42A in the clutch 42 circumferential direction increasing on progression toward the left side. The clutch 42 is coaxially fitted into the insertion hole 40A of the coupling gear 40, with the coupling protrusions 42A fitted together with the coupling recesses 40B of the insertion hole 40A.

A coupling spring 44 (compression coil spring, see FIG. 3A) serving as an urging member is provided at the left side of the clutch 42, and the shaft 24 is coaxially inserted through the coupling spring 44. A substantially circular ring-shaped anchor plate 46 serving as an anchoring member is provided at the left side of the coupling spring 44, the shaft 24 is coaxially inserted through the anchor plate 46 such that the anchor plate 46 is supported by the shaft 24 in a manner so as not to be able to move in the axial direction thereof (left-right direction). The coupling spring 44 is compressed in the axial direction (left-right direction) between the clutch 42 and the anchor plate 46, with the coupling spring 44 urging the clutch 42 toward the right side. The coupling spring 44 accordingly limits release of the fitting together of the coupling protrusions 42A of the clutch 42 with the coupling recesses 40B of the coupling gear 40 (the insertion hole 40A), and the coupling spring 44 thereby limits relative rotation of the clutch 42 and the shaft 24 with respect to the coupling gear 40. The coupling spring 44 is coupled to the coupling gear 40 and to the clutch 42 and the shaft 24 so as to be capable of rotating as a single body therewith, and when the coupling gear 40 is rotated the clutch 42 and the shaft 24 are rotated as a single body therewith.

A base end portion of an elongated plate-shaped operation lever 48 serving as an operation section is linked to the left side of the shaft 24 so as to be capable of rotating integrally therewith, with the operation lever 48 disposed at the left side of the case 22. A manual lever 50 serving as a manual portion is mechanically connected to a leading end portion of the operation lever 48 through a cable 52, with the manual lever 50 manually operable by the occupant. Operating the manual lever 50 accordingly enables the operation lever 48 to be swung in the release direction B through the cable 52.

Next, description follows regarding operation and advantageous effects of the present exemplary embodiment.

In the actuator 10 of the transmission 12 configured as described above, the shaft 24 and the motor 26 are coupled by the coupling mechanism 32 (the worm 34, the helical gear 36, the worm shaft 38, the coupling gear 40, the clutch 42, and the coupling spring 44).

Moreover, in the actuator 10, the worm 34, the helical gear 36, and the worm shaft 38 are rotated by the motor 26 being forward driven under control of the control device 28, and the coupling gear 40, the clutch 42, and the shaft 24 are thereby rotated in the lock direction A. The lock plate 16 is accordingly swung toward the right side by the link shaft 20 being rotated in the lock direction A and the switching shaft 18 being moved toward the rear side. Rotation of the lock gear 14 is accordingly locked by the locking portion 16A of the lock plate 16, and the shift position of the transmission 12 is at the parking position.

Furthermore, in the actuator 10, the worm 34, the helical gear 36, and the worm shaft 38 are rotated by the motor 26 being reverse driven under control of the control device 28, and the coupling gear 40, the clutch 42, and the shaft 24 are thereby rotated in the release direction B. The link shaft 20 is thereby rotated in the release direction B and the switching shaft 18 is moved toward the front side such that the lock plate 16 is swung toward the left side. The rotational locking of the lock gear 14 by the locking portion 16A of the lock plate 16 is thereby released, and the parking position of the transmission 12 is released.

However, suppose the motor 26 were to be un-drivable due to a malfunction or the like of the transmission 12 or a vehicle battery (not illustrated in the drawings), then there would sometimes be a need to release the parking position of the transmission 12 (so as to enable movement of the vehicle).

Thus in such cases the manual lever 50 would be operated, and the operation lever 48 rotationally operated in the release direction B through the cable 52, thereby releasing the fitting of the coupling protrusions 42A of the clutch 42 into the coupling recesses 40B of the coupling gear 40 (the insertion hole 40A) against an urging force of the coupling spring 44, such that the shaft 24 and the clutch 42 are rotationally operated as a single body with the operation lever 48, in the release direction B with respect to the coupling gear 40. The link shaft 20 is accordingly rotated in the release direction B, and the rotational locking of the lock gear 14 by the locking portion 16A of the lock plate 16 is released by the switching shaft 18 moving toward the front side, and the parking position of the transmission 12 is thereby released.

In this manner, the coupling between the shaft 24 and the motor 26 by the coupling mechanism 32 (the coupling of the shaft 24 and the clutch 42 to the coupling gear 40) is released by rotational operation force to the shaft 24, the shaft 24 is rotated in the release direction B, and the parking position of the transmission 12 is released. There is accordingly no need for a device to release the coupling between the shaft 24 and the motor 26 by the coupling mechanism 32 (i.e. the solenoid in above Patent Document 1), with this both simplifying the configuration of the actuator 10 and enabling the actuator 10 to be made more compact and at lower cost.

Moreover, the coupling mechanism 32 couples the shaft 24 to the motor 26 using the urging force of the coupling spring 44. Furthermore, when the shaft 24 is rotationally operated via the manual lever 50, the cable 52, and the operation lever 48, coupling between the shaft 24 and the motor 26 by the coupling mechanism 32 is released against the urging force of the coupling spring 44 by the rotational operation force to the shaft 24. Thus the coupling mechanism 32 is able to couple the shaft 24 to the motor 26 using a simple configuration, and the coupling between the shaft 24 and the motor 26 is also able to be released by the coupling mechanism 32.

Moreover, the worm shaft 38 restricts rotation of the coupling gear 40. Furthermore, the coupling protrusions 42A of the clutch 42 are fitted into the coupling recesses 40B of the coupling gear 40 (the insertion hole 40A) by the urging force of the coupling spring 44, such that rotation of the clutch 42 and the shaft 24 with respect to the coupling gear 40 is limited. This enables rotation of the shaft 24 to be limited with a simple configuration, and enables undesirable rotation of the shaft 24 to be suppressed.

Furthermore, the coupling of the shaft 24 and the clutch 42 with the coupling gear 40 is released against the urging force of the coupling spring 44 both when a large load has been input to the shaft 24 from the lock gear 14 via the lock plate 16, the switching shaft 18, and the link shaft 20, and when a large load has been input to the shaft 24 from the manual lever 50 via the cable 52 and the operation lever 48. This accordingly enables a large load to be suppressed from being transmitted to the worm 34, the helical gear 36, the worm shaft 38, and the coupling gear 40, and enables the worm 34, the helical gear 36, the worm shaft 38, and the coupling gear 40 to be suppressed from breaking.

Note that in the present exemplary embodiment the coupling recesses 40B are provided at the coupling gear 40 and the coupling protrusions 42A are provided at the clutch 42. However, the coupling protrusions 42A may be provided at the coupling gear 40 and the coupling recesses 40B provided at the clutch 42.

In the present exemplary embodiment the operation lever 48 is linked to the shaft 24. However, the operation lever 48 may also be configured so as not to be linked to the shaft 24. In such cases the shaft 24 may be configured so as to be rotatable using a tool.

Furthermore, in the present exemplary embodiment, the worm 34 (first gear) restricts rotation of the helical gear 36 (second gear), and the worm shaft 38 (third gear) restricts rotation of the coupling gear 40 (fourth gear). However, the worm shaft 38 may restrict rotation of the coupling gear 40 without the first gear restricting rotation of the second gear. Moreover, the worm 34 configuring the limiting mechanism may restrict rotation of the helical gear 36 configuring the limiting mechanism without the third gear restricting rotation of the fourth gear.

The entire content of the disclosure of Japanese Patent Application No. 2020-76925 filed on Apr. 23, 2020, is incorporated by reference in the present specification.

### EXPLANATION OF THE REFERENCE NUMERALS

10 actuator (release device)
12 transmission
24 shaft (rotating section)
26 motor (drive mechanism)
32 coupling mechanism
38 worm shaft (limiting mechanism, worm)
40 coupling gear (limiting mechanism, worm wheel)

1. A release device comprising:
a rotating section configured to be provided at a transmission of a vehicle and configured to release a parking position of the transmission by being rotated;
a drive mechanism; and
a coupling mechanism configured to couple the rotating section to the drive mechanism such that the rotating section is rotated by the drive mechanism being driven, and such that coupling between the rotating section and the drive mechanism is released by operational force applied to the rotating section so that the rotating section is rotated.

2. The release device of claim 1, wherein the coupling mechanism is configured to couple the rotating section to the drive mechanism using urging force, and configured such that coupling between the rotating section and the drive mechanism by the coupling mechanism is released against the urging force by the operational force applied to the rotating section.

3. The release device of claim 1, further comprising a limiting mechanism provided at the coupling mechanism and configured to limit rotation of the rotating section.

4. The release device of claim 3, further comprising:
a worm provided at the limiting mechanism; and
a worm wheel provided at the limiting mechanism, the worm wheel being configured to mesh with the worm, and the worm limiting rotation of the worm wheel such that rotation of the rotating section is limited.

5. The release device of claim 3, wherein coupling between the rotating section and the drive mechanism by the coupling mechanism is released at a side of the rotating section and not at the limiting mechanism in the coupling mechanism.

6. The release device of claim 1, wherein:
a coupling protrusion and a coupling recess are provided at the coupling mechanism; and
the coupling mechanism couples the rotating section to the drive mechanism by the coupling protrusion being inserted into the coupling recess, and coupling between the rotating section and the drive mechanism by the coupling mechanism is released by release of the insertion of the coupling protrusion into the coupling recess.

7. The release device of claim 6, further comprising:
a coupling member rotatably provided at the coupling mechanism,
wherein the coupling protrusion or the coupling recess is provided at the coupling member, and insertion of the coupling protrusion into the coupling recess is released by the coupling member being moved in an axis direction of the rotating section.
